(19) United States
(12) Patent Application Publication
(10) Pub. No.: US 2026/0131571 A1
(43) Pub. Date: May 14, 2026

(54) LIQUID DISCHARGE HEAD, HEAD MODULE, AND LIQUID DISCHARGE APPARATUS

(71) Applicant: Yu WATANABE, Kanagawa (JP)

(72) Inventor: Yu WATANABE, Kanagawa (JP)

(21) Appl. No.: 19/350,080

(22) Filed: Oct. 6, 2025

(30) Foreign Application Priority Data
Nov. 12, 2024 (JP) 2024-197457

(51) Int. Cl. B41J 2/14; B41J 2/16; B41J 2/21

(52) U.S. Cl. CPC B41J 2/14233; B41J 2/161; B41J 2/1623; B41J 2/2103

(57) ABSTRACT

A liquid discharge head includes: a substrate component includes: a nozzle to discharge a liquid; a channel communicating with the nozzle; and a frame bonded to the substrate component with an adhesive in a lamination direction, the frame including a communicating portion communicating with the channel. The frame and the substrate component have: a bonding region in which the frame and the substrate component are bonded with the adhesive; and a non-bonding region in which the frame and the substrate component are not bonded with the adhesive. The bonding region has: a first bonding region around the communicating portion of the frame; and a second bonding region at both end portions of the frame in a longitudinal direction of the frame orthogonal to the lamination direction, and the non-bonding region has a hollow portion between the end portions of the frame.

### CROSS-REFERENCE TO RELATED APPLICATION

This patent application is based on and claims priority pursuant to 35 U.S.C. § 119(a) to Japanese Patent Application No. 2024-197457, filed on Nov. 12, 2024, in the Japan Patent Office, the entire disclosure of which is hereby incorporated by reference herein.

### BACKGROUND

### Technical Field

The present embodiment relates to a liquid discharge head, a head module, and a liquid discharge apparatus.

### Related Art

A liquid discharge head includes a substrate component including at least a nozzle for discharging liquid, a channel communicating with the nozzle, and a piezoelectric element, and a frame including a communicating portion communicating with the channel and bonded to the substrate component with an adhesive.

The liquid discharge head has a bonding region in which a head case is bonded with an adhesive and a non-bonding region in which the head case is not bonded with an adhesive. The bonding region and the non-bonding region are provided between a head body that is a substrate component and a head case that is a frame. In addition, a potting agent flows into a portion of the non-bonding region between the head body and the head case, and the head case is bonded to the head body also by the potting agent flowing into the non-bonding region. The potting agent fills an opening provided in the head case and protects a drive IC that drives a piezoelectric element.

However, there is a possibility that liquid discharging performance may be deteriorated.

### SUMMARY

The present disclosure described herein provides a liquid discharge head including: a substrate component includes: a nozzle to discharge a liquid; a channel communicating with the nozzle; and a frame bonded to the substrate component with an adhesive in a lamination direction, the frame including a communicating portion communicating with the channel. The frame and the substrate component have: a bonding region in which the frame and the substrate component are bonded with the adhesive; and a non-bonding region in which the frame and the substrate component are not bonded with the adhesive. The bonding region has: a first bonding region around the communicating portion of the frame; and a second bonding region at both end portions of the frame in a longitudinal direction of the frame orthogonal to the lamination direction, and the non-bonding region has a hollow portion between the end portions of the frame.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external perspective explanatory view of a liquid discharge head according to the present embodiment;

FIG. 2 is a view for explaining bonding between a MEMS component and a frame in the present embodiment;

FIG. 3A is a perspective view illustrating a bonding region in a comparative example;

FIG. 3B is a cross-sectional view taken along a line A-A in FIG. 3A;

FIG. 3C is a view illustrating a stress distribution in a nozzle forming region of a MEMS component in the comparative example;

FIGS. 4A and 4B are views for explaining bonding of the frame and the MEMS component according to the present embodiment;

FIG. 5A is a perspective view illustrating a bonding region of the present embodiment;

FIG. 5B is a cross-sectional view taken along a line B-B of FIG. 5A;

FIG. 5C is a view illustrating a stress distribution in a nozzle forming region of the MEMS component in the present embodiment;

FIG. 6 is a view for explaining an example in which a non-bonding region is divided into a plurality of regions with the bonding region;

FIG. 7 is a view for explaining an example in which a bonding region at an end portion in a longitudinal direction and a bonding region around a common supply main channel and a common collection main channel are discontinuous;

FIGS. 8A and 8B are views for explaining an example in which a groove portion is formed at a position corresponding to a non-bonding region of the frame;

FIGS. 9A and 9B are views for explaining an example in which a portion corresponding to a non-bonding region of the frame is opened;

FIG. 10 is an exploded perspective explanatory view of a head module of the present embodiment;

FIG. 11 is an exploded perspective explanatory view of the head module according to the present embodiment as viewed from a nozzle face side;

FIG. 12 is a schematic explanatory view of a printer according to the present embodiment;

FIG. 13 is a plan explanatory view of an example of a head unit of the printer;

FIG. 14 is a plan explanatory view of a main portion of an example of the printer;

FIG. 15 is a side explanatory view of the main portion of an example of the printer;

FIG. 16 is a plan explanatory view of the main portion of an example of a liquid discharge unit; and

FIG. 17 is a front explanatory view of an example of the liquid discharge unit according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

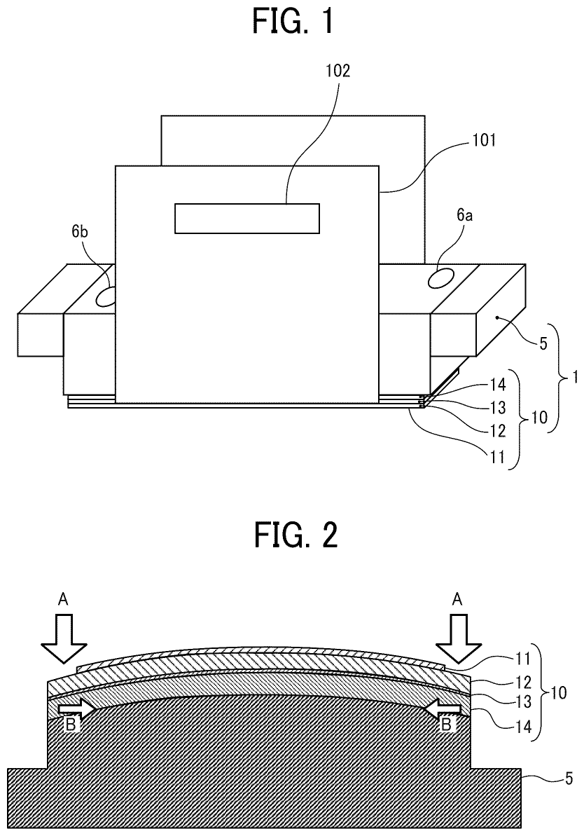

Description will be given below of a liquid discharge head installed in a liquid discharge apparatus according to an embodiment. FIG. 1 is an external perspective explanatory view of a liquid discharge head according to the present embodiment.

A liquid discharge head 1 of the present embodiment includes a micro electro mechanical systems (MEMS) component 10 that is a substrate component, a frame 5, and a substrate (flexible wiring substrate) 101 on which a drive circuit 102 is mounted. The MEMS component 10 includes a nozzle substrate 11, an actuator substrate 12, a damper member 13, and a channel substrate 14.

The nozzle substrate 11 is provided with a plurality of nozzles 24 that discharges liquid. The actuator substrate 12 includes an individual channel substrate, a diaphragm, a piezoelectric element 23, and a common channel substrate. The individual channel substrate forms a plurality of pressure chambers (individual liquid chambers) respectively communicating with the plurality of nozzles 24, a plurality of individual supply channels respectively communicating with the plurality of pressure chambers, and a plurality of individual collection channels respectively communicating with the plurality of pressure chambers. One pressure chamber and the individual supply channel and the individual collection channel communicating with the one pressure chamber will be collectively referred to as an individual channel.

The diaphragm forms a deformable wall surface of the pressure chamber, and the piezoelectric element 23 is integrally provided on the diaphragm. The diaphragm has a supply-side opening that communicates with the individual supply channel and a collection-side opening that communicates with the individual collection channel. The piezoelectric element 23 is a pressure generator such as an electromechanical transducer element to deform the diaphragm to apply pressure to the liquid in the pressure chamber.

The individual channel substrate and the diaphragm are not limited to being separate members. For example, the individual channel substrate and the diaphragm can be integrally formed with the same member using a silicon on insulator (SOI) substrate. In other words, it is possible to use the SOI substrate in which a silicon oxide film, a silicon layer, and a silicon oxide film are formed in this order on a silicon substrate, use the silicon substrate as the individual channel substrate, and form the diaphragm with the silicon oxide film, the silicon layer, and the silicon oxide film. In this configuration, the layer configuration of the silicon oxide film, the silicon layer, and the silicon oxide film of the SOI substrate becomes the diaphragm. As described above, the diaphragm includes one formed with a material formed on a surface of the individual channel substrate.

The common channel substrate forms a plurality of common supply branch channels and a plurality of common collection branch channels alternately adjacent to each other in a longitudinal direction of the head. The common supply branch channel communicates with a plurality of individual supply channels via the supply-side opening provided in the diaphragm. The common collection branch channel communicates with a plurality of individual collection channels via the collection-side opening provided in the diaphragm.

A lower portion of a common supply main channel extending in the longitudinal direction of the head leading to the plurality of common supply branch channels is provided on one end side in a transverse direction of the head of the common channel substrate. In addition, a lower portion of a common collection main channel extending in the longitudinal direction of the head leading to a plurality of common collection branch channels is provided on the other end side in the transverse direction of the head of the common channel substrate. The common supply main channel and the common collection main channel are configured by stacking the common channel substrate, the channel substrate 14, and the frame 5.

The damper member 13 includes a supply-side damper forming a deformable wall surface of the common supply branch channel of the common channel substrate, and a collection-side damper forming a deformable wall surface of the common collection branch channel.

The common supply branch channel and the common collection branch channel are configured by sealing groove portions alternately arranged on the common channel substrate, which is the same member, with the damper member 13 formed with a thin plate.

As the damper member 13, a metal thin film or an inorganic thin film resistant to an organic solvent is preferably used, and a thickness thereof is preferably 10 [μm] or less. The damper member 13 preferably has a stacked structure including a plurality of layers. In addition, in order to satisfy a function necessary as a damper, the damper member 13 preferably has a compliance of 7×10-17 [m/N] or more, a Young's modulus of 3 [GPa] or more and 200 [GPa] or less, and a thickness of 2 [μm] or more and 10 [μm] or less.

The damper member 13 suppresses influence (for example, crosstalk) of pressure fluctuation in a channel (for example, the individual supply channel) generated at the time of liquid discharge from the nozzle 24 on the liquid discharge from another nozzle 24. Specifically, as a result of the damper member 13 appropriately exhibiting a damper function, it is possible to suppress occurrence of crosstalk in which vibration (pressure fluctuation) at the time of liquid discharge propagates via liquid and affects liquid discharge from adjacent nozzles 24, and to stabilize liquid discharge accuracy from each nozzle 24.

The channel substrate 14 is also a damper holding substrate that holds the damper member 13, and a middle portion 21a of the common supply main channel is formed at one end in the transverse direction of the head of the channel substrate 14. Further, a middle portion 21b of the common collection channel is formed along a long side of the head at the other end in the transverse direction of the head of the channel substrate 14. In addition, a groove portion for forming a space in which the supply-side damper and the collection-side damper can vibrate is formed in a portion facing the supply-side damper of the damper member 13 on a lower surface of the channel substrate 14 and a portion facing the collection-side damper.

The nozzle substrate 11, the individual channel substrate of the actuator substrate 12, the diaphragm, the common channel substrate, and the channel substrate 14 are all silicon substrates.

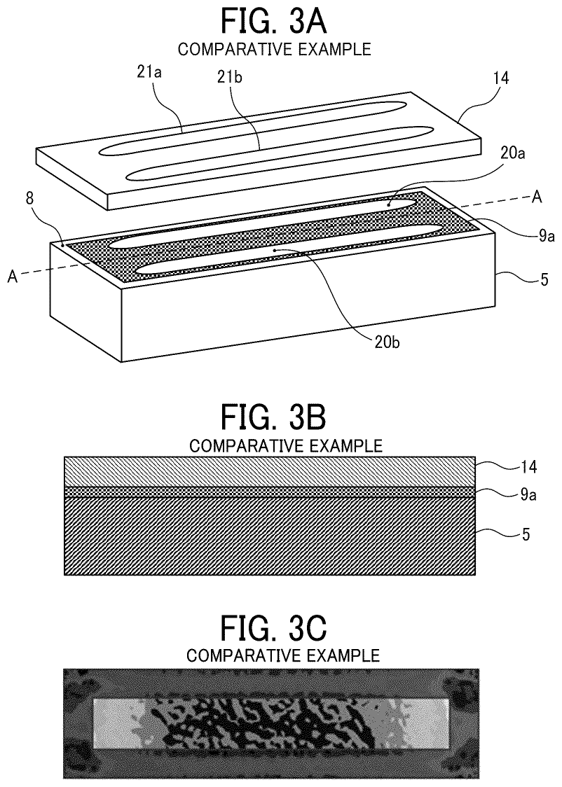

The frame 5 is formed with a resin or a metal, and an upper portion 20a (see FIGS. 3A to 3C) of a groove-shaped common supply main channel extending in the longitudinal direction of the head is formed at one end in the transverse direction of the head of a bonding surface 8 (see FIG. 3A) to the MEMS component 10. An upper portion 20b (see FIGS. 3A to 3C) of a groove-shaped common collection main channel extending in the longitudinal direction of the head is formed at the other end in the transverse direction of the head of the bonding surface 8.

In the present embodiment, a lower portion of the common supply main channel provided on the common channel substrate of the actuator substrate 12, a middle portion 21a of the common supply main channel provided on the channel substrate 14, and the upper portion 20a of the common supply main channel provided on the frame 5 are stacked to form the common supply main channel leading to a plurality of common supply branch channels. In addition, a lower portion of the common collection main channel provided in the common channel substrate of the actuator substrate 12, a middle portion 21b of the common collection main channel provided in the channel substrate 14, and the upper portion 20b of the common collection main channel provided in the frame 5 are stacked to form a common collection main channel leading to a plurality of common supply branch channels.

A channel leading to the common supply main channel is formed on one end side in the longitudinal direction of the head of the frame 5, and this channel penetrates vertically in the drawing, and an opening on an upper surface is a supply port 6a. Further, a channel leading to the common collection main channel is formed on the other end side in the longitudinal direction of the head of the frame 5, and this channel penetrates vertically in the drawing, and an opening on the upper surface is a collection port 6b.

The MEMS component 10 integrated by bonding a plurality of silicon substrates and the frame 5 formed with a resin or a metal are bonded by a thermosetting adhesive.

FIG. 2 is a view for explaining bonding between the MEMS component 10 and the frame 5.

As illustrated in FIG. 2, when the MEMS component 10 and the frame 5 are bonded to each other, a thermosetting adhesive is applied to the bonding surface 8 of the frame 5, and the adhesive is thermally cured while being pressurized from above and below as indicated by an arrow A in the drawing.

After the thermosetting adhesive is cured and the MEMS component 10 and the frame 5 are bonded to each other, the MEMS component 10 and the frame 5 thermally shrink when the MEMS component 10 and the frame 5 return to a room temperature. A linear expansion coefficient of the adhesive formed with a resin and the frame 5 formed with a resin or a metal is larger than the linear expansion coefficient of the MEMS component 10 mainly formed with a silicon substrate. As a result, an amount of thermal shrinkage of the adhesive and the frame 5 is larger than that of the MEMS component 10. The MEMS component 10 receives a stress in a direction indicated by an arrow B in the drawing at a bonding interface due to a difference in amount of thermal shrinkage between the adhesive and the frame 5.

FIG. 3A is a perspective view illustrating a bonding region 9a having a configuration in a comparative example, and FIG. 3B is a cross-sectional view taken along a line A-A of FIG. 3A. FIG. 3C is a view illustrating a stress distribution in a nozzle forming region (corresponding to piezoelectric-element arrangement region) of the MEMS component 10 after the frame 5 is bonded in the configuration in the comparative example. In FIG. 3C, a darker portion indicates a higher stress.

As illustrated in FIG. 3A, in the comparative example, an adhesive is applied to the entire bonding surface 8 of the frame 5 to bond the frame 5 to the bonding surface of the channel substrate 14 of the MEMS component 10.

As illustrated in FIG. 3C, in the configuration in the comparative example, the stress to be applied to the MEMS component 10 on the center side in the longitudinal direction is high, and the difference in stress to be applied to the MEMS component 10 between the central portion and the end portion in the longitudinal direction is large. This is because the temperature is lowered to the room temperature after the frame 5 and the MEMS component 10 are bonded, so that the frame 5 having a large linear expansion coefficient tends to shrink more than the MEMS component 10 having a small linear expansion coefficient. In this event, the bonding surface 8 of the frame 5 is bonded to the MEMS component 10 and constrained, and thus, it is difficult to displace in the longitudinal direction, but the side opposite to the bonding surface side of the frame 5 is not constrained, and thus, it is easy to displace in the longitudinal direction. As described above, there is a difference in ease of shrinkage between the bonding surface side of the frame 5 and the side opposite to the bonding surface side, whereby the frame 5 is deformed such that the center in the longitudinal direction protrudes toward the MEMS component 10. Due to this deformation, the center of the MEMS component 10 in the longitudinal direction is pressed toward the nozzle substrate 11. As a result, it is considered that the stress to be applied to the MEMS component 10 on the center side in the longitudinal direction is increased.

Further, a stress for shrinking the MEMS component 10 acts on the entire bonding surface of the channel substrate 14 of the MEMS component 10 from the adhesive and the frame. Due to the stress for shrinking the MEMS component 10 and the pressing force generated by the deformation of the frame 5, as illustrated in FIG. 2, the center side in the longitudinal direction of the MEMS component 10 is warped so as to protrude in the liquid discharge direction.

When warpage occurs in the MEMS component 10, vibration characteristics of the diaphragm are different in the longitudinal direction, a droplet discharge speed is different in the longitudinal direction, or a discharge direction of the liquid discharged from the nozzle 24 is different in the longitudinal direction, so that discharge characteristics are changed in the longitudinal direction, which affects discharging performance.

Thus, in the present embodiment, a bonding region in which the frame 5 and the MEMS component 10 are to be bonded with an adhesive and a non-bonding region not to be bonded with an adhesive are provided between the frame 5 and the MEMS component 10, and the frame 5 is partially bonded to the MEMS component 10.

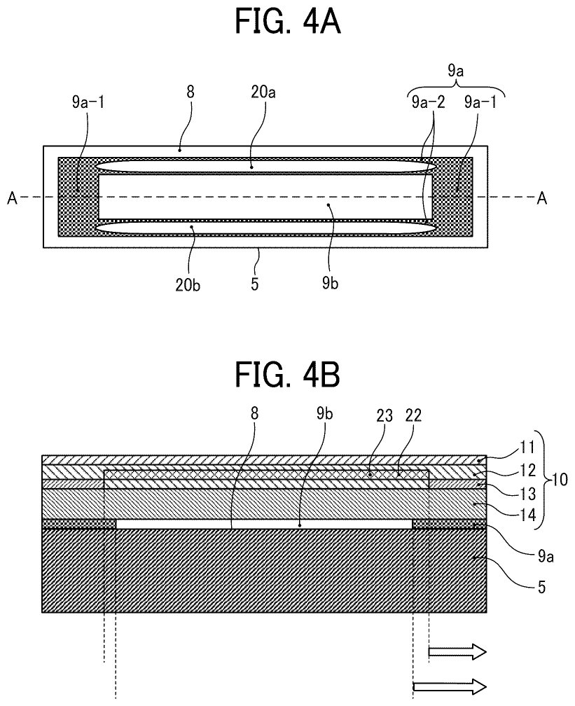

FIGS. 4A and 4B are views for explaining bonding of the frame 5 and the MEMS component 10 according to the present embodiment. FIG. 4A is a schematic view illustrating the bonding surface 8 of the frame 5. FIG. 4B is a cross-sectional view taken along a line A-A of FIG. 4A in the liquid discharge head.

As illustrated in FIG. 4A, in the present embodiment, the adhesive is applied only on both sides of the bonding surface 8 of the frame 5 in the longitudinal direction of the head, and around the upper portion 20a of the common supply main channel and the upper portion 20b of the common collection main channel as the communicating portion. As a result, the bonding region 9a to be bonded to the MEMS component 10 includes only the bonding regions 9a-1 on both sides in the longitudinal direction of the head and the bonding regions 9a-2 around the common supply main channel and the common collection main channel. The central portion of the bonding surface 8 of the frame 5 serves as a non-bonding region 9b, and a predetermined gap (cavity) is formed between the frame 5 and the MEMS component 10. As illustrated in FIG. 4B, in the present embodiment, the bonding regions 9a-1 on both sides in the longitudinal direction extend to the end portion side in the longitudinal direction of the piezoelectric-element arrangement region 22 (corresponding to nozzle forming region).

The bonding region 9a can be controlled by controlling an application amount of the adhesive and the pressing force at the time of bonding and controlling wet spreading at the time of pressing. For example, by controlling the amount of the adhesive to be applied to the bonding surface 8 of the frame 5 at the time of dispensing application and controlling the pressure at the time of heating to control a film thickness of the adhesive, a width of the adhesive that wets and spreads can be controlled to control the bonding region 9a.

The adhesive preferably has a Young's modulus of 2 GPa or more after thermal curing. By using an adhesive having a Young's modulus after thermal curing of 2 GPa or more as the adhesive, the frame 5 can be firmly bonded to the MEMS component 10 even if the bonding area is narrow.

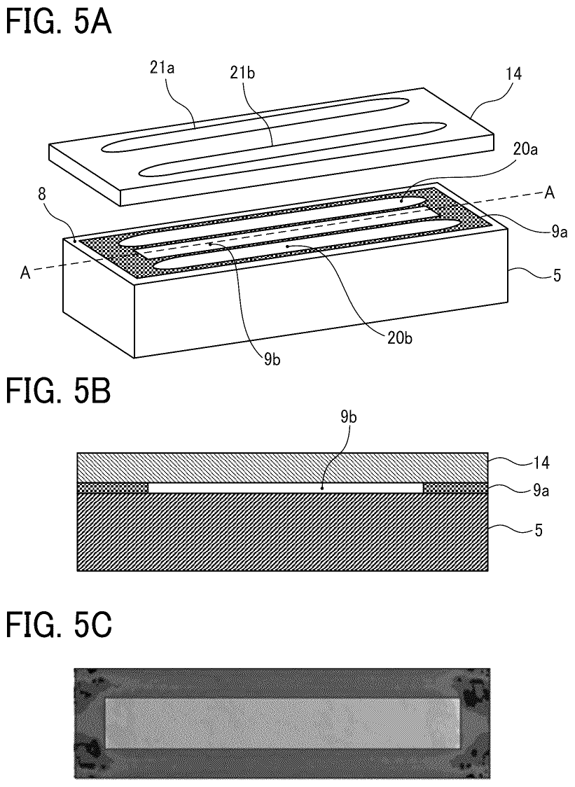

FIG. 5A is a perspective view illustrating the bonding region 9a of the present embodiment, and FIG. 5B is a cross-sectional view taken along a line A-A of FIG. 5A. FIG. 5C is a view illustrating a stress distribution in a nozzle forming region (corresponding to piezoelectric-element arrangement region 22) of the MEMS component 10 after the frame 5 is bonded in the present embodiment.

In the present embodiment, as illustrated in FIG. 5C, the stress to be applied to the MEMS component 10 can be made substantially uniform in the nozzle forming region. As illustrated in FIGS. 5A and 5B, the central portion of the head is the non-bonding region 9b, has a predetermined gap between the frame 5 and the MEMS component 10, and is a hollow portion. Thus, even if the frame 5 is deformed such that the center of the frame 5 in the longitudinal direction protrudes toward the MEMS component 10 due to the difference in thermal shrinkage between the frame 5 and the MEMS component 10, the center of the MEMS component 10 in the longitudinal direction is not pressed toward the nozzle substrate 11. As a result, it is considered that the stress to be applied to the center of the MEMS component 10 in the longitudinal direction is reduced, and the stress to be applied to the MEMS component 10 can be made substantially uniform.

In addition, as compared with FIG. 3C, the stress to be applied to the nozzle forming region is reduced as compared with the configuration in the comparative example. In the non-bonding region 9b, no stress acts to shrink the MEMS component 10 from the frame 5 via the adhesive. The bonding region 9a-2 for liquid sealing around the common supply main channel and the common collection main channel on both sides in the transverse direction is located outside the nozzle forming region. As a result, the stress to be applied to the MEMS component 10 in the bonding region 9a around the common supply main channel and the common collection main channel on both sides in the transverse direction does not reach the nozzle forming region. As a result, as illustrated in FIG. 5C, it is considered that the stress to be applied to the MEMS component 10 in the nozzle forming region can be reduced.

As described above, in the present embodiment, the stress to be applied to the nozzle forming region in the region that affects the discharging performance can be made uniform, so that it is possible to suppress the vibration characteristics of the diaphragm from being different in the longitudinal direction. In addition, the warpage of the MEMS component can be suppressed, and the droplet discharging performance can be stabilized.

In the present embodiment, the frame 5 is bonded only with a thermosetting adhesive, and is not bonded with other materials. As a result, the stress to be applied to the MEMS component 10 due to the thermal shrinkage of the frame 5 can be set to both sides in the longitudinal direction of the head, around the common supply main channel, and around the common collection main channel, and the stress to be applied to the MEMS component 10 can be satisfactorily reduced.

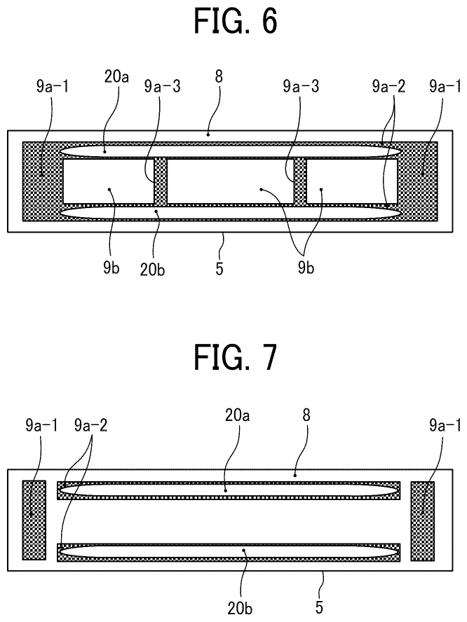

In a case where the stress to be applied to the central portion in the longitudinal direction of the MEMS component 10 is not so strong in a case where a degree of deformation at the time of thermal shrinkage of the frame 5 is small or in a case where the difference in linear expansion coefficient between the frame 5 and the MEMS component 10 is small, the configuration illustrated in FIG. 6 may be adopted. The configuration illustrated in FIG. 6 is a configuration in which a plurality of bonding regions 9a-3 extending in the transverse direction of the head and coupling the bonding region 9a-2 for sealing the common supply main channel and the bonding region 9a-2 for sealing the common collection main channel are provided, and the non-bonding region 9b is divided into a plurality of regions. With the configuration illustrated in FIG. 6, the bonding area is increased as compared with the configuration illustrated in FIGS. 4A and 4B, and the frame 5 can be favorably bonded to the MEMS component 10.

In addition, as illustrated in FIG. 7, a length in the longitudinal direction of the bonding region at the end portion in the longitudinal direction may be shorter than that in the configuration illustrated in FIGS. 4A and 4B, and the bonding region 9a-1 at the end portion in the longitudinal direction and the bonding region 9a-2 around the common supply main channel and the common collection main channel may not be coupled. In such a configuration, the bonding region 9a-1 at the end portion in the longitudinal direction does not reach the piezoelectric-element arrangement region 22, and the area of the bonding region 9a-1 at the end portion in the longitudinal direction is reduced as compared with the configuration illustrated in FIGS. 4A, 4B and 6. As a result, the stress to be applied to the MEMS component 10 can be reduced as compared with the configuration illustrated in FIGS. 4A, 4B, and 6. Thus, in a case where the difference in linear expansion coefficient between the frame 5 and the MEMS component 10 is large, occurrence of warpage of the MEMS component 10 can be favorably suppressed by adopting the configuration illustrated in FIG. 7.

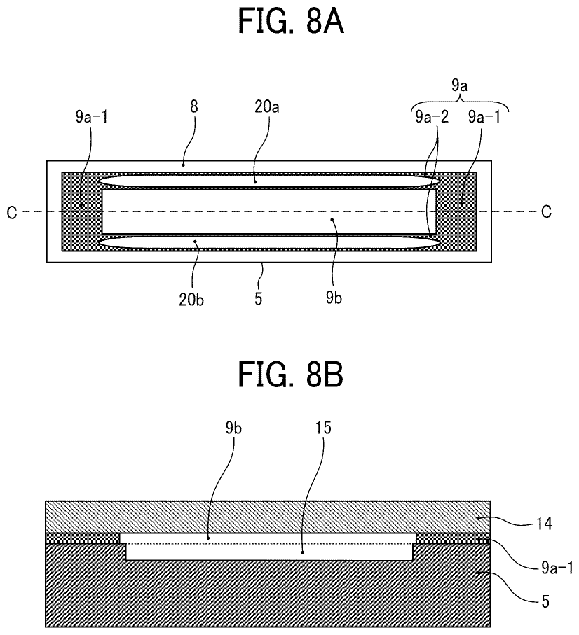

FIGS. 8A and 8B are views illustrating an example in which a groove portion 15 for preventing wet-spreading of the adhesive is provided at a position corresponding to the non-bonding region 9b of the bonding surface 8 of the frame 5. FIG. 8A is a view illustrating the bonding surface 8 of the frame 5, and FIG. 8B is a cross-sectional view taken along a line C-C of FIG. 8A.

As illustrated in FIGS. 8A and 8B, by providing the groove portion 15 in the frame 5, the bonding region 9a can be formed in a desired region. In addition, a volume of the frame 5 can be reduced, and thermal shrinkage of the frame 5 at the time of returning to the room temperature after the adhesive is thermally cured can be reduced. As a result, the stress to be applied to the MEMS component 10 via the adhesive can be reduced, and occurrence of warpage of the MEMS component 10 can be further suppressed.

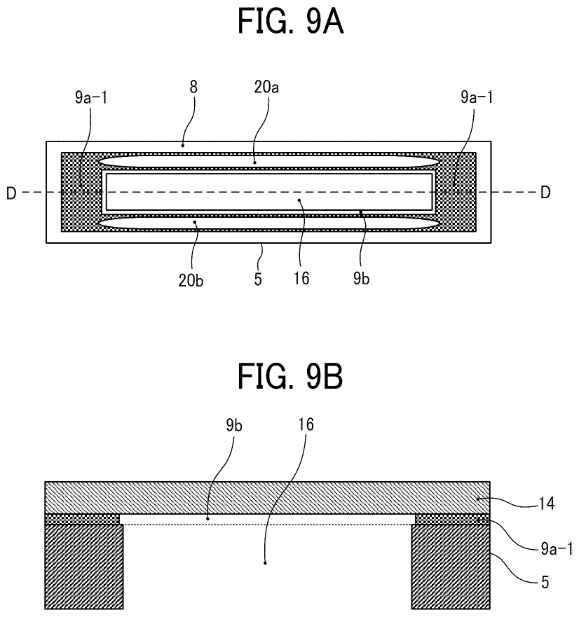

FIGS. 9A and 9B are an example in which a portion corresponding to the non-bonding region 9b of the frame 5 is opened, FIG. 9A is a view illustrating the bonding surface 8 of the frame 5, and FIG. 9B is a cross-sectional view taken along a line D-D of FIG. 9A.

As illustrated in FIGS. 9A and 9B, in the configuration in which the portion corresponding to the non-bonding region 9b of the frame 5 is opened to form a through hole 16, similarly to FIGS. 8A and 8B, wet-spreading of the adhesive can be prevented, and the bonding region 9a can be formed in a desired region. In addition, by the through hole 16 being provided, a volume of the frame 5 can be reduced as compared with the configuration illustrated in FIGS. 8A and 8B. As a result, as compared with the configuration illustrated in FIGS. 8A and 8B, the thermal shrinkage of the frame 5 at the time of returning to the room temperature after the adhesive is thermally cured can be reduced.

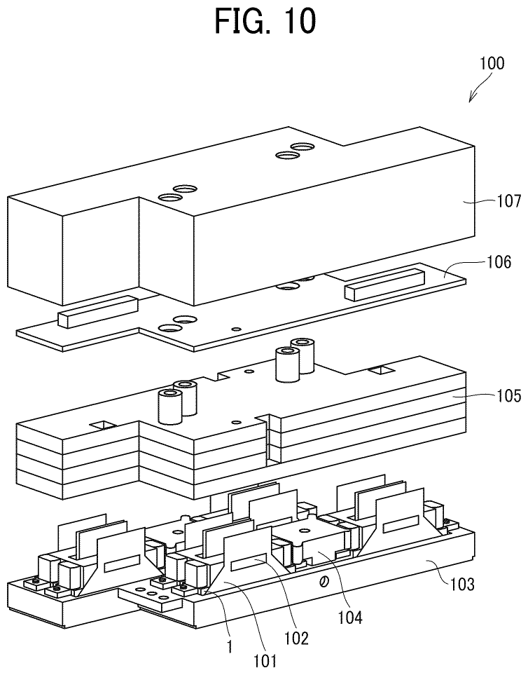

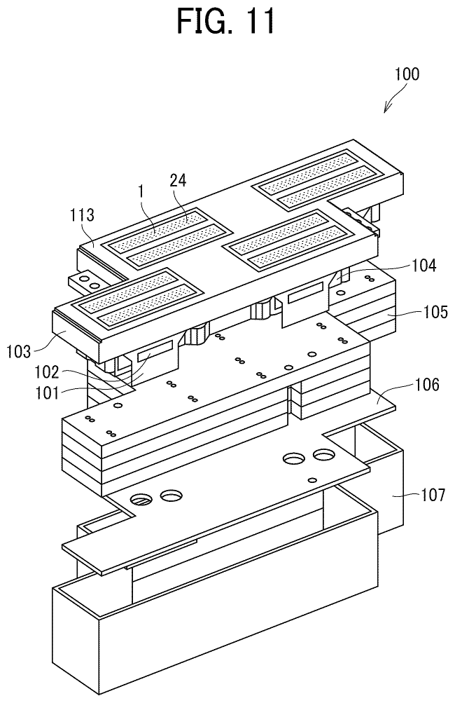

Next, an example of a head module including the liquid discharge head 1 of the present embodiment will be described with reference to FIGS. 10 and 11.

FIG. 10 is an exploded perspective explanatory view of the head module of the present embodiment.

FIG. 11 is an exploded perspective explanatory view of the head module according to the present embodiment as viewed from a nozzle face side.

The head module 100 includes a liquid discharge head (hereinafter, also simply referred to as a “head”) 1 that discharges liquid, a base member 103 that holds the plurality of liquid discharge heads 1, and a cover member 113 that serves as a nozzle cover of the plurality of liquid discharge heads 1. Further, the head module 100 further includes a heat dissipating member 104, a manifold 105 defining channels to supply liquid to the plurality of liquid discharge heads 1, a printed circuit board (PCB) 106 coupled to the flexible wiring substrate 101, and a module case 107.

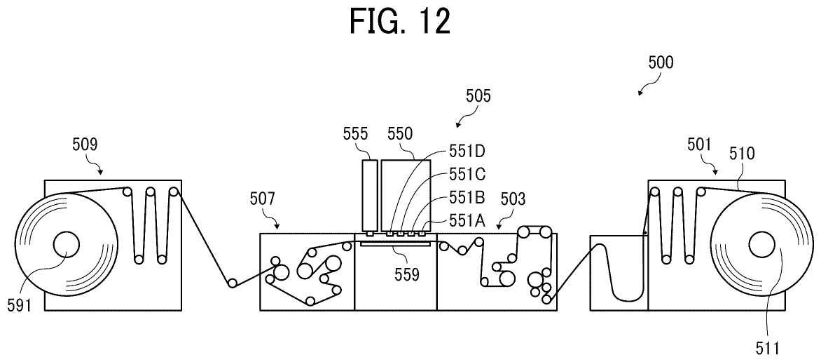

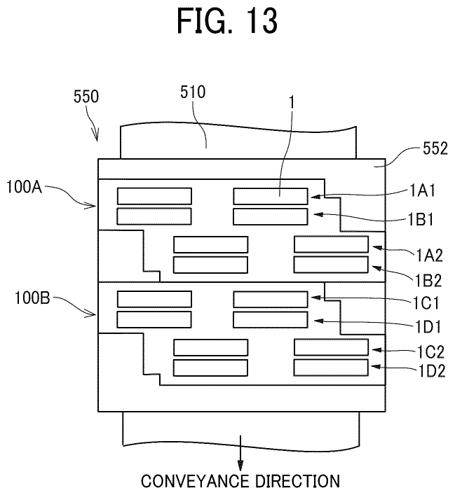

Next, an example of a liquid discharge apparatus according to the present embodiment will be described with reference to FIGS. 12 and 13.

FIG. 12 is an explanatory diagram schematically illustrating a printer that is an inkjet recording apparatus serving as the liquid discharge apparatus in the present embodiment.

FIG. 11 is a plan explanatory view of an example of a head unit of the printer according to the present embodiment.

A printer 500 serving as the liquid discharge apparatus includes a feeder 501 that feeds a continuous medium 510, a guide conveyor 503 that guides and conveys the continuous medium 510, fed from the feeder 501, to a printing unit 505, the printing unit 505 that discharges liquid onto the continuous medium 510 to form an image on the continuous medium 510, a dryer 507 to dry the continuous medium 510, and an ejector 509 that ejects the continuous medium 510.

The continuous medium 510 is fed from a winding roller 511 of the feeder 501, guided and conveyed with rollers of the feeder 501, the guide conveyor 503, the dryer 507, and the ejector 509, and wound around a take-up roller 591 of the ejector 509. In the printing unit 505, the continuous medium 510 is conveyed while facing the head unit 550 on a conveyance guide member 559. An image is formed on the continuous medium 510 with liquid discharged from the head units 550 and 555. The head unit 550 includes head modules 551A to 551D each discharges different colors.

In the printer 500 of the present embodiment, the head unit 550 includes two head modules 100A, 100B according to the present embodiment described above on a common base member 552.

Further, liquid of the same color is discharged from head arrays 1A1, 1A2 of the head module 100A when an arrangement direction of the liquid discharge heads 1 in a direction orthogonal to a conveyance direction of the head modules 100A, 100B is set as a head array direction. In a similar manner, liquid of desired color is discharged from a pair of head arrays 1B1, 1B2 of the head module 100A, a pair of head arrays 1C1, 1C2 of the head module 100B, and a pair of head arrays 1D1, 1D2.

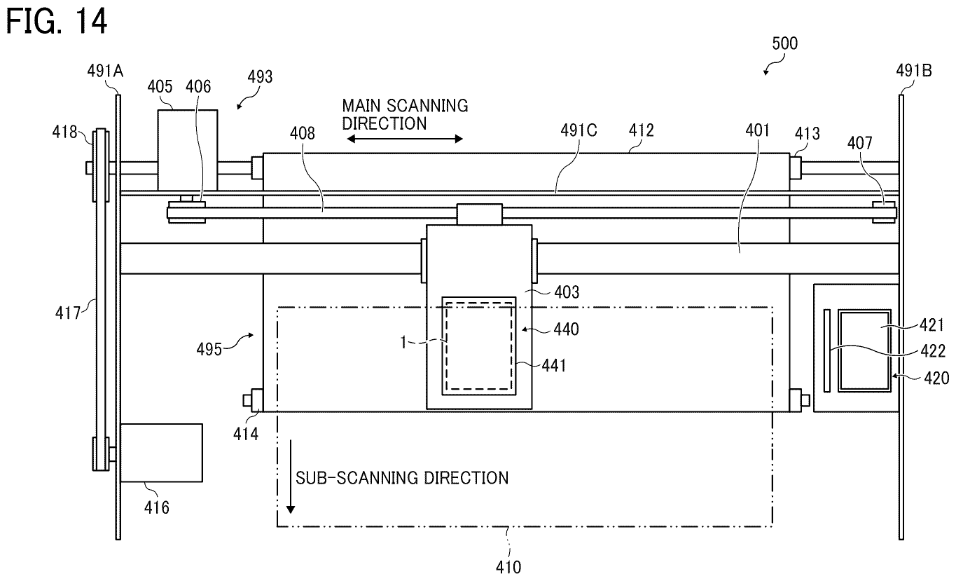

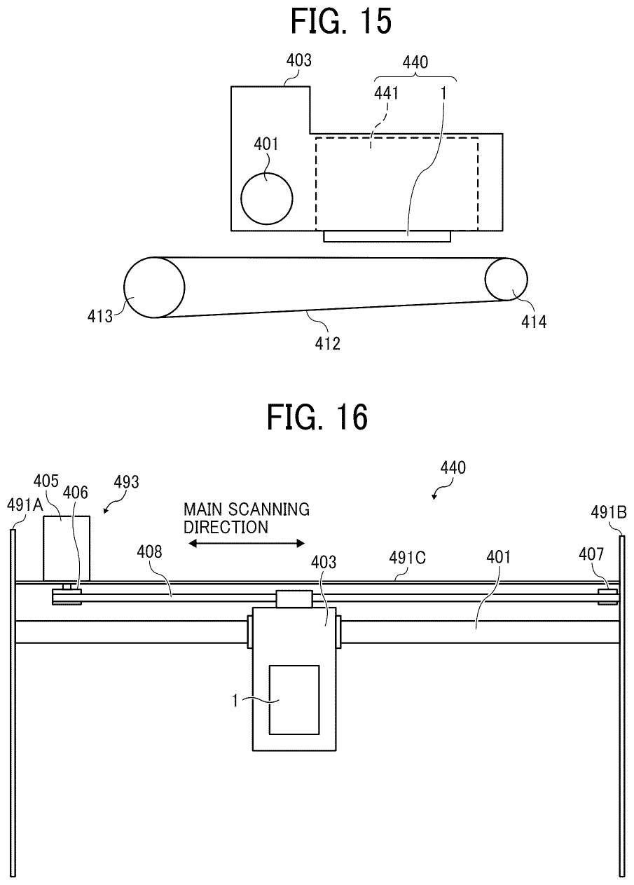

Next, another example of the printer serving as the liquid discharge apparatus according to the present embodiment will be described with reference to FIGS. 14 and 15.

FIG. 14 is a plan explanatory diagram illustrating a main portion of the printer of the present example.

FIG. 15 is a side explanatory diagram illustrating the main portion of the printer of the present example.

The printer 500 of the present example is a serial-type apparatus, and a carriage 403 is reciprocally moved in a main scanning direction by a main scanning moving mechanism 493. The main scanning moving mechanism 493 includes a guide member 401, a main scanning motor 405, a timing belt 408, and the like. The guide member 401 is bridged between a left-side plate 491A and a right-side plate 491B to movably hold the carriage 403.

The main scanning motor 405 reciprocally moves the carriage 403 in the main scanning direction via the timing belt 408 bridged between a drive pulley 406 and a driven pulley 407.

The carriage 403 carries a liquid discharge unit 440 including the liquid discharge head 1 according to the present embodiment and a head tank 441 as a single integrated unit. The liquid discharge head 1 of the liquid discharge unit 440 discharges liquid of each color, for example, yellow (Y), cyan (C), magenta (M), and black (K). Further, the liquid discharge head 1 includes a nozzle array including a plurality of nozzles 24 arranged in a sub-scanning direction that is orthogonal to the main scanning direction, and is mounted so that a discharge direction faces downward. The liquid discharge head 1 is coupled to a liquid circulation apparatus, and liquid of desired color is circulated and supplied.

The printer 500 includes a conveyance mechanism 495 to convey a sheet 410. The conveyance mechanism 495 includes a conveyance belt 412 as a conveyor and a sub-scanning motor 416 to drive the conveyance belt 412. The conveyance belt 412 attracts the sheet 410 and conveys the sheet 410 to a position facing the liquid discharge head 1. The conveyance belt 412 is an endless belt stretched between a conveyance roller 413 and a tension roller 414. Attraction may be applied by electrostatic attraction, air suction, or the like. Further, the conveyance belt 412 rotates in the sub-scanning direction as the conveyance roller 413 is rotationally driven by a sub-scanning motor 416 via the timing belt 417 and the timing pulley 418.

At one side in the main scanning direction of the carriage 403, a maintenance mechanism 420 to maintain the liquid discharge head 1 in good condition is disposed on a lateral side of the conveyance belt 412. The maintenance mechanism 420 includes, for example, a cap member 421 to cap a nozzle surface of the liquid discharge head 1 and a wiper member 422 to wipe the nozzle surface. The main scanning moving mechanism 493, the maintenance mechanism 420, and the conveyance mechanism 495 are mounted onto a housing including a left-side plate 491A, a right-side plate 491B and a back plate 491C.

In the printer 500 thus configured, the sheet 410 is fed and attracted to the conveyance belt 412 and is conveyed in the sub-scanning direction by cyclic rotation of the conveyance belt 412. Thus, the liquid discharge head 1 is driven in response to image signals while the carriage 403 moves in the main scanning direction, to discharge liquid to the sheet 410 stopped, thus forming an image on the sheet 410.

Next, another example of the liquid discharge unit according to the present embodiment will be described with reference to FIG. 16.

FIG. 16 is a plan explanatory view illustrating a main portion of the liquid discharge unit of the present example.

The liquid discharge unit 440 includes a housing including the left-side plate 491A, the right-side plate 491B, and the back plate 491C, the main scanning moving mechanism 493, the carriage 403, and the liquid discharge head 1 among components of the liquid discharge apparatus.

Note that, in the liquid discharge unit 440, the maintenance mechanism 420 described above may be further mounted on the right-side plate 491B, for example.

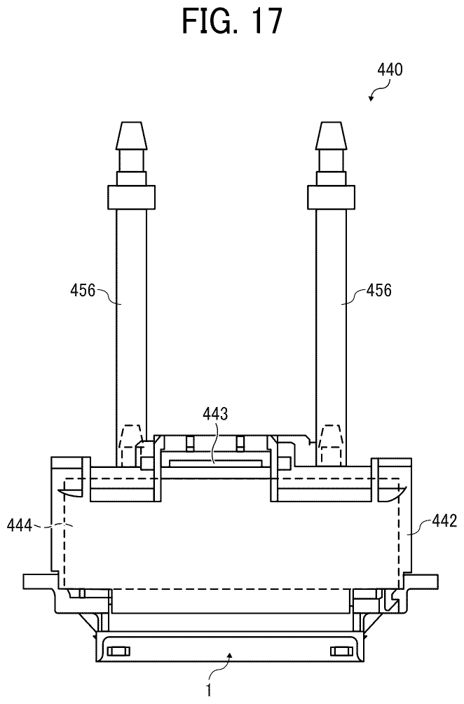

Next, still another example of the liquid discharge unit according to the present embodiment will be described with reference to FIG. 17.

FIG. 17 is a front explanatory view illustrating the liquid discharge unit of the present example.

The liquid discharge unit 440 includes the liquid discharge head 1 to which a channel component 444 is attached, and a tube 456 coupled to the channel component 444.

Note that the channel component 444 is disposed inside a cover 442. Instead of the channel component 444, the liquid discharge unit 440 may include the head tank 441. Further, a connector 443 electrically connected with the liquid discharge head 1 is provided on an upper portion of the channel component 444.

In the present embodiment, discharged liquid is not limited to particular liquid as long as the liquid has a viscosity or surface tension to be discharged from a head. However, preferably, the viscosity of the liquid is not greater than 30 mPa's under the room temperature and ordinary pressure or by heating or cooling. Specific examples of such liquid include, but are not limited to, solutions, suspensions, and emulsions containing solvents such as water and organic solvents, colorants such as dyes and pigments, functionality imparting materials such as polymerizable compounds, resins and surfactants, biocompatible materials such as deoxyribonucleic acid (DNA), amino acid, protein and calcium, and/or edible materials such as natural colorants. Such liquid can be used as inkjet inks, surface treatment liquid, liquid for forming compositional elements of electric or luminous elements or electronic circuit resist patterns, and three-dimensional object forming material liquid.

Examples of an energy source to discharge liquid include a piezoelectric actuator (a stacked piezoelectric element or a thin-film piezoelectric element), a thermal actuator that employs a thermoelectric conversion element, such as a heating resistor, and an electrostatic actuator including a diaphragm and opposed electrodes.

The “liquid discharge unit” is a structure including the liquid discharge head and a functional component(s) or mechanism(s) combined to the liquid discharge head to form a single unit and is an assembly of components relating to liquid discharge. For example, the “liquid discharge unit” includes a combination of the liquid discharge head with at least one of the head tank, the carriage, the supply mechanism, the maintenance mechanism, the main scanning moving mechanism, or the liquid circulation apparatus.

Examples of the “single unit” include a combination in which the liquid discharge head and one or more functional components and mechanisms are secured to each other through, e.g., fastening, bonding, or engaging, and a combination in which one of the liquid discharge head and the functional components and mechanisms is movably held by another. The liquid discharge head may be detachably attached to the functional component(s) or mechanism(s).

For example, the liquid discharge head and the head tank may form the liquid discharge unit as a single unit. Alternatively, the liquid discharge head and the head tank coupled to each other with a tube, or the like, may form the liquid discharge unit as a single unit. Here, a unit including a filter may be added at a position between the head tank and the liquid discharge head of the liquid discharge unit.

Further, the liquid discharge head and the carriage may form the liquid discharge unit as a single unit.

Still further, the liquid discharge unit may include the liquid discharge head movably held by a guide member that forms a portion of the main scanning moving mechanism, so that the liquid discharge head and the main scanning moving mechanism form a single unit. The liquid discharge unit may include the liquid discharge head, the carriage, and the main scanning moving mechanism that form a single unit.

In still another example, a cap member that forms a portion of the maintenance mechanism may be secured to the carriage to which the liquid discharge head is attached so that the liquid discharge head, the carriage, and the maintenance mechanism form a single unit to form the liquid discharge unit.

Further, in still another example, the liquid discharge unit may include a tube coupled to the head tank or the liquid discharge head to which a channel component is attached so that the liquid discharge head and the supply mechanism form a single unit. Liquid in a liquid reservoir source is supplied to the liquid discharge head through this tube.

The main scanning moving mechanism includes a single guide member. Further, the supply mechanism includes a single tube or a single loading unit.

Note that while “liquid discharge unit” is described as a combination with the liquid discharge head here, the “liquid discharge unit” includes a head module including the above-described liquid discharge head, and a head unit in which the above-described functional components and mechanisms are combined to form a single unit.

The “liquid discharge apparatus” includes an apparatus which includes the liquid discharge head, the liquid discharge unit, the head module, the head unit, and the like, and discharges liquid by driving the liquid discharge head. The liquid discharge apparatus includes an apparatus capable of discharging liquid to a material to which liquid can adhere or an apparatus that discharges liquid toward gas or into liquid.

The “liquid discharge apparatus” may further include devices relating to feeding, conveying, and ejecting of the medium onto which liquid can adhere and also include a pretreatment apparatus and an aftertreatment apparatus.

The “liquid discharge apparatus” includes, for example, an image forming apparatus that forms an image on a sheet by discharging ink, or a three-dimensional fabrication apparatus that discharges fabrication liquid to a powder layer in which powder material is formed in layers, so as to form a three-dimensional object.

The “liquid discharge apparatus” is not limited to an apparatus that discharges liquid to visualize images having meaning such as letters or figures. For example, the liquid discharge apparatus includes an apparatus that forms patterns having no meaning or an apparatus that fabricates three-dimensional images.

The above-described term “medium onto which liquid can adhere” represents a medium on which liquid at least temporarily adheres, a medium on which liquid adheres and is fastened, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of the “material onto which liquid can adhere” include any material on which liquid can adhere even temporarily, such as paper, thread, fiber, fabric, leather, metal, plastic, glass, wood, and ceramic.

Further, the “liquid discharge apparatus” is an apparatus that relatively moves the liquid discharge head and a material on which liquid can adhere. However, the liquid discharge apparatus is not limited to such an apparatus. For example, the liquid discharge apparatus may be a serial-type apparatus that moves the liquid discharge head or a line-type apparatus that does not move the liquid discharge head.

Examples of the liquid discharge apparatus further include: a treatment liquid applying apparatus that discharges treatment liquid onto a sheet to apply the treatment liquid to the surface of the sheet, for reforming a surface of the sheet; and an injection granulation apparatus that injects composition liquid, in which a raw material is dispersed in a solution, through a nozzle to granulate fine particle of the raw material.

Note that the terms “image formation”, “recording”, “printing”, “image printing”, and “fabricating” used herein may be used synonymously with each other.

A liquid discharge head (1) includes: a substrate component (10) including: a nozzle (24) to discharge a liquid; a channel (21a, 21b) communicating with the nozzle (24); and a frame (5) bonded to the substrate component with an adhesive in a lamination direction, the frame including a communicating portion (20a, 20b) communicating with the channel. The frame (5) and the substrate component have: a bonding region (9a) in which the frame (5) and the substrate component (10) are bonded with the adhesive; and a non-bonding region (9b) in which the frame (5) and the substrate component (10) are not bonded with the adhesive. The bonding region (9a) has: a first bonding region around the communicating portion (20a, 20b) of the frame (5); and a second bonding region at both end portions of the frame (5) in a longitudinal direction of the frame orthogonal to the lamination direction, and the non-bonding region (9b) has a hollow portion between the end portions of the frame (5).

The non-bonding region (9b) has the hollow portion at a central portion of the frame (5) between the both end portions of the second bonding region of the frame (5) in the longitudinal direction. The non-bonding region (9b) includes multiple communicating portions (20a, 20b) including the communicating portion (20a, 20b), the hollow portion of the non-bonding region (9b) is disposed between the multiple communicating portions (20a, 20b) in a transverse direction orthogonal to each of the longitudinal direction and the lamination direction, and the non-bonding region (9b) has an area larger than an area of the bonding region (9a) in the central portion of the frame (5) in the longitudinal direction.

The first bonding region and the second bonding region are discontinuous. The substrate component (10) includes an actuator substrate including a piezoelectric element (23) in a piezoelectric-element arrangement region, and the first bonding region overlaps a part of an end portion of the piezoelectric-element arrangement region in the longitudinal direction in a cross section of the liquid discharge head (1) in the lamination direction.

The non-bonding region (9b) includes multiple communicating portions (20a, 20b) including the communicating portion (20a, 20b), the multiple communicating portions are on both sides of the frame in a transverse direction orthogonal to each of the longitudinal direction and the lamination direction, in a central portion of the frame (5) in the longitudinal direction, the hollow portion of the non-bonding region (9b) is disposed between the multiple communicating portions (20a, 20b) in the transverse direction, and the bonding region includes: multiple first bonding regions, including the first bonding region (9a-2), at both ends of the frame in the transverse direction; and a third bonding region: connecting the multiple first bonding regions (9a-2) across the hollow portion in the transverse direction; and partitioning the hollow portion into multiple non-bonding regions.

The frame has a groove portion (15) facing the non-bonding region of the frame (5). The frame has a through hole (16) facing the non-bonding region of the frame (5). The substrate component has a linear expansion coefficient smaller than that of the frame (5). The substrate component is formed with a member including silicon. The adhesive includes a thermosetting resin, and the adhesive has a linear expansion coefficient larger than that of the substrate component. The adhesive has a Young's modulus after curing of 2 GPa or more.

A head module (100) includes multiple liquid discharge heads (1) including the liquid discharge head (1). A liquid discharge apparatus includes: the liquid discharge head (1); and a holder holding the liquid discharge head (1). The liquid discharge apparatus includes: the head module (100); and a holder holding the head module (100).

According to the present embodiment, it is possible to satisfactorily suppress deterioration of liquid discharging performance.

The above-described embodiments are limited examples, and the present disclosure includes, for example, the following aspects having advantageous effects.

### Aspect 1

According to Aspect 1, a liquid discharge head 1 includes: a substrate component such as a MEMS component 10 including at least a nozzle 24 that discharges liquid, a channel (individual channel or common channel) communicating with the nozzle 24, and a piezoelectric element 23; and a frame 5 that includes a communicating portion (in the present embodiment, the upper portion 20a of the common supply main channel and the upper portion 20b of the common collection main channel) communicating with the channel, the frame being bonded to the substrate component with an adhesive. The frame 5 and the substrate component have a bonding region 9a to be bonded with the adhesive and a non-bonding region 9b not to be bonded. The bonding region 9a is provided at least around the communicating portion of the frame 5 and at an end portion of the substrate component. The substrate component and the frame 5 are bonded to each other only with one adhesive.

In general, the substrate component is mainly formed with silicon, or the like, and the frame 5 is formed with a resin material or a metal having a linear expansion coefficient larger than that of the substrate component. As described above, the linear expansion coefficient of the frame 5 is larger than the linear expansion coefficient of the substrate component, and thus, an amount of thermal expansion and thermal shrinkage of the frame 5 is larger than that of the substrate component. As the adhesive for bonding the substrate component and the frame 5, a thermosetting type is generally used, and when the substrate component and the frame 5 are bonded to each other by heating the substrate component and the frame 5 to cure the adhesive, and then the substrate component and the frame are returned to a room temperature, the amount of thermal shrinkage of the frame 5 becomes larger than that of the substrate component. As a result, a stress to shrink the substrate component is generated through the bonding region between the substrate component and the frame 5. Due to the stress, the substrate component is warped in a convex shape such that the central portion on the nozzle side protrudes in the discharge direction, which may affect the discharging performance of the liquid from the nozzle 24.

In comparative example, a bonding region in which the frame 5 and the substrate component are to be bonded with an adhesive and a non-bonding region not to be bonded with an adhesive are provided between the frame 5 and the substrate component. By partially bonding the frame to the substrate component, in the non-bonding region, the stress due to the difference in the amount of thermal shrinkage with the frame 5 does not act on the substrate component, and the warpage of the substrate component can be reduced.

However, in comparative example, a potting agent flows into a portion of the non-bonding region, and a portion of the non-bonding region is filled with the potting agent. Thus, in the non-bonding region filled with the potting agent, a stress due to a difference in the amount of thermal shrinkage acts on the substrate component at least via the potting agent, and there is a possibility that the stress acting on the substrate component cannot be achieved as intended.

On the other hand, in Aspect 1, all the non-bonding regions are hollow portions not filled with members, and thus, a stress due to the difference in the amount of thermal shrinkage from the frame 5 is not applied to the substrate component in all the non-bonding regions. As a result, the stress acting on the substrate component can be well controlled.

Further, a bonding region is provided at least around the communicating portion of the frame necessary for liquid sealing and at the end portion of the frame. As described with reference to FIGS. 3A to 3C, the stress due to the difference in thermal shrinkage from the frame applied to the substrate component via the adhesive increases toward the center of the substrate component. Thus, by firmly bonding the frame to the substrate component at the end portion of the frame where the stress to be applied to the substrate component is weaker than that on the center side, it is possible to secure a non-bonding region having as large an area as possible on the center side and to reduce the area of the bonding region on the center side. As a result, a stress to be applied to the substrate component can be reduced, warpage of the substrate component can be favorably suppressed, and deterioration of liquid discharging performance can be favorably suppressed.

### Aspect 2

According to Aspect 2, in the liquid discharge head 1 of Aspect 1, the bonding region 9a is only around the communicating portion (in the present embodiment, the upper portion 20a of the common supply main channel and the upper portion 20b of the common collection main channel) of the frame 5 and at the end portion of the frame 5 in a longitudinal direction.

According to this, as described with reference to FIG. 7, as compared with the case where the frame 5 has a bonding region at a portion other than around the communicating portion (in the present embodiment, the upper portion 20a of the common supply main channel and the upper portion 20b of the common collection main channel) of the frame 5 and the end portion in the longitudinal direction of the frame 5, the bonding area can be reduced, and the stress to be applied to the substrate component such as the MEMS component 10 via the bonding region due to the thermal shrinkage of the frame when returning to the room temperature after the thermal curing of the adhesive can be reduced. Thus, even in a case where the difference in linear expansion coefficient between the frame 5 and the substrate component is large, the occurrence of warpage of the substrate component can be satisfactorily suppressed, and deterioration in discharging performance can be suppressed.

### Aspect 3

According to Aspect 3, in the liquid discharge head 1 of Aspect 2, the bonding region 9a-2 around the communicating portion (in the present embodiment, the upper portion 20a of the common supply main channel and the upper portion 20b of the common collection main channel) and the bonding region 9a-1 at the end portion in the longitudinal direction are discontinuous.

According to this, as described with reference to FIG. 7, as compared with the case where the bonding region 9a-2 around the communicating portion (in the present embodiment, the upper portion 20a of the common supply main channel and the upper portion 20b of the common collection main channel) and the bonding region 9a-1 at the end portion in the longitudinal direction are continuous, the bonding area can be reduced, and the stress on the substrate component such as the MEMS component 10 through the bonding region due to the thermal shrinkage of the frame when returning to the room temperature after the thermal curing of the adhesive can be reduced. Thus, even in a case where the difference in linear expansion coefficient between the frame 5 and the substrate component is large, the occurrence of warpage of the substrate component can be satisfactorily suppressed, and deterioration in discharging performance can be suppressed.

### Aspect 4

According to Aspect 4, in the liquid discharge head 1 of Aspect 1, the bonding region 9a-1 at the end portion is provided at the end portion in the longitudinal direction of the frame 5, and in a cross section perpendicular to a transverse direction of the liquid discharge head, the bonding region at the end portion overlaps an end portion side in the longitudinal direction of a piezoelectric-element arrangement region 22 where the piezoelectric element 23 is arranged.

According to this, as described with reference to FIGS. 4A to 5C, even if a portion of the bonding region overlaps with the end portion side in the longitudinal direction of the piezoelectric-element arrangement region 22, the stress to be applied to the nozzle forming region of the substrate component such as the MEMS component 10 can be made substantially uniform, and the stress to be applied to the nozzle forming region can be reduced as compared with the case where the entire surface of the frame is bonded to the substrate component. As a result, the occurrence of warpage of the substrate component can be satisfactorily suppressed, and deterioration in discharging performance can be suppressed.

### Aspect 5

According to Aspect 5, in the liquid discharge head 1 of any one of Aspects 1 to 4, the communicating portion (in the present embodiment, the upper portion 20a of the common supply main channel and the upper portion 20b of the common collection main channel) is provided on both sides in a transverse direction of the frame 5, the bonding region 9a-1 at the end portion is provided at an end portion in the longitudinal direction of the frame, and a center side overlapping the piezoelectric-element arrangement region 22 in which the piezoelectric element 23 is arranged between the frame 5 and the substrate component such as the MEMS component 10 has the bonding region 9a-3 coupling the bonding region 9a-2 around the communicating portion provided on one side in the transverse direction and the bonding region 9a-2 around the communicating portion provided on the other side in the transverse direction, and one or more non-bonding regions 9b.

According to this, as described with reference to FIG. 6, the plurality of non-bonding regions 9b having the predetermined gap between the frame and the substrate component such as the MEMS component 10 is provided on the center side in the longitudinal direction of the frame. It is therefore possible to reduce the stress related to the substrate component when the center side in the longitudinal direction of the frame is deformed so as to protrude toward the substrate component side when returning to the room temperature after the thermal curing of the adhesive, and reduce the stress for shrinking the substrate component related to the substrate component through the adhesive. This makes it possible to suppress the occurrence of warpage in the substrate component. In addition, as compared with a case where there is no bonding region 9a-3 that couples the bonding region 9a-2 around the communicating portion provided on one side in the transverse direction and the bonding region 9a-2 around the communicating portion provided on the other side in the transverse direction, the bonding area can be expanded, and the frame 5 can be favorably bonded to the substrate component.

### Aspect 6

According to Aspect 6, in the liquid discharge head 1 of any one of Aspects 1 to 5, the groove portion 15 is provided at a position corresponding to the non-bonding region 9b of the frame 5.

According to this, as described with reference to FIGS. 8A and 8B, it is possible to prevent the adhesive applied to the bonding region of the frame 5 from wet-spreading to the non-bonding region 9b and bonding the portion to be the non-bonding region 9b. As a result, the desired region can be set as the bonding region. In addition, a volume of the frame is reduced, the amount of thermal shrinkage of the frame when returning to the room temperature after the thermal curing of the adhesive can be suppressed, and the stress to be applied to the substrate component such as the MEMS component 10 can be reduced.

### Aspect 7

According to Aspect 7, in the liquid discharge head 1 of any one of Aspects 1 to 5, the through hole 16 is provided at a position corresponding to the non-bonding region 9b of the frame 5.

According to this, as described with reference to FIGS. 9A and 9B, it is possible to prevent the adhesive applied to the bonding region of the frame 5 from wet-spreading to the non-bonding region 9b and bonding the portion to be the non-bonding region 9b. As a result, the desired region can be set as the bonding region. In addition, a volume of the frame is reduced, the amount of thermal shrinkage of the frame when returning to the room temperature after the thermal curing of the adhesive can be suppressed, and the stress to be applied to the substrate component such as the MEMS component 10 can be reduced.

### Aspect 8

According to Aspect 8, in the liquid discharge head 1 of any one of Aspects 1 to 7, a linear expansion coefficient of the substrate component such as the MEMS component 10 is smaller than a linear expansion coefficient of the frame 5.

According to this, as described in the embodiment, the stress is applied to the substrate component such as the MEMS component 10 by the thermal shrinkage of the frame when returning to the room temperature after the thermal curing of the adhesive, but the warpage of the substrate component due to the stress can be favorably suppressed by providing the configuration of any one of the Aspects 1 to 7.

### Aspect 9

According to Aspect 9, in the liquid discharge head 1 of any one of Aspects 1 to 8, the substrate component such as the MEMS component is formed with a member mainly including silicon.

According to this, the substrate component such as the MEMS component can be manufactured by a MEMS or semiconductor device microfabrication technique.

### Aspect 10

According to Aspect 10, in the liquid discharge head 1 of any one of Aspects 1 to 9, the adhesive is a thermosetting resin, and has a linear expansion coefficient larger than that of the substrate component such as the MEMS component 10.

According to this, the stress is applied to the substrate component such as the MEMS component 10 by the thermal shrinkage of the adhesive when returning to the room temperature after the thermal curing of the adhesive, but the occurrence of the warpage of the substrate component due to the stress can be favorably suppressed by providing the configuration of any one of the Aspects 1 to 7.

### Aspect 11

According to Aspect 11, in the liquid discharge head 1 of any one of Aspects 1 to 10, a Young's modulus of the adhesive after curing is 2 GPa or more.

According to this, as described in the embodiment, the frame 5 can be firmly bonded to the substrate component such as the MEMS component 10.

### Aspect 12

According to Aspect 12, a head module 100 includes the liquid discharge head 1, wherein the liquid discharge head of any one of Aspects 1 to 11 is used as the liquid discharge head.

According to this, the head module 100 having favorable discharging performance can be provided.

### Aspect 13

According to Aspect 13, a liquid discharge apparatus includes the liquid discharge head of any one of Aspects 1 to 11 or the head module of Aspect 12.

According to this, it is possible to provide a liquid discharge apparatus having favorable discharging performance.

1. A liquid discharge head comprising:
a substrate component including:
a nozzle to discharge a liquid;
a channel communicating with the nozzle; and
a frame bonded to the substrate component with an adhesive in a lamination direction, the frame including a communicating portion communicating with the channel,
wherein the frame and the substrate component have:
a bonding region in which the frame and the substrate component are bonded with the adhesive; and
a non-bonding region in which the frame and the substrate component are not bonded with the adhesive,
the bonding region has:
a first bonding region around the communicating portion of the frame; and
a second bonding region at both end portions of the frame in a longitudinal direction of the frame orthogonal to the lamination direction, and
the non-bonding region has a hollow portion between the end portions of the frame.

2. The liquid discharge head according to claim 1,
wherein the non-bonding region has the hollow portion at a central portion of the frame between the both end portions of the second bonding region of the frame in the longitudinal direction.

3. The liquid discharge head according to claim 2,
wherein the non-bonding region includes multiple communicating portions including the communicating portion,
the hollow portion of the non-bonding region is disposed between the multiple communicating portions in a transverse direction orthogonal to each of the longitudinal direction and the lamination direction, and
the non-bonding region has an area larger than an area of the bonding region in the central portion of the frame in the longitudinal direction.

4. The liquid discharge head according to claim 2,
wherein the first bonding region and the second bonding region are discontinuous.

5. The liquid discharge head according to claim 1,
wherein the substrate component includes an actuator substrate including a piezoelectric element in a piezoelectric-element arrangement region, and
the first bonding region overlaps a part of an end portion of the piezoelectric-element arrangement region in the longitudinal direction in a cross section of the liquid discharge head in the lamination direction.

6. The liquid discharge head according to claim 1,
wherein the non-bonding region includes multiple communicating portions including the communicating portion,
the multiple communicating portions are on both sides of the frame in a transverse direction orthogonal to each of the longitudinal direction and the lamination direction,
in a central portion of the frame in the longitudinal direction,
the hollow portion of the non-bonding region is disposed between the multiple communicating portions in the transverse direction, and
the bonding region includes:
multiple first bonding regions, including the first bonding region, at both ends of the frame in the transverse direction; and
a third bonding region:
connecting the multiple first bonding regions across the hollow portion in the transverse direction; and
partitioning the hollow portion into multiple non-bonding regions.

7. The liquid discharge head according to claim 1,
wherein the frame has a groove portion facing the non-bonding region of the frame.

8. The liquid discharge head according to claim 1,
wherein the frame has a through hole facing the non-bonding region of the frame.

9. The liquid discharge head according to claim 1,
wherein the substrate component has a linear expansion coefficient smaller than that of the frame.

10. The liquid discharge head according to claim 1,
wherein the substrate component is formed with a member including silicon.

11. The liquid discharge head according to claim 1,
wherein the adhesive includes a thermosetting resin, and
the adhesive has a linear expansion coefficient larger than that of the substrate component.

12. The liquid discharge head according to claim 1,
wherein the adhesive has a Young's modulus after curing of 2 GPa or more.

13. A head module comprising multiple liquid discharge heads including the liquid discharge head according to claim 1.

14. A liquid discharge apparatus comprising:
the liquid discharge head according to claim 1; and
a holder holding the liquid discharge head.

15. A liquid discharge apparatus comprising:
the head module according to claim 13; and
a holder holding the head module.
